(19) United States
(12) Patent Application Publication
(10) Pub. No.: US 2007/0193105 A1
(43) Pub. Date: Aug. 23, 2007

(54) Fishing Rod with a Sports Style Handle

(76) Inventors: Michael Alan Miller, Shreveport, LA (US); Julianne Goodman Miller, Shreveport, LA (US)

Correspondence Address: Michael Alan Miller, 511 Longleaf Rd, Shreveport, LA, 71106, US

(21) Appl. No.: 11/307,784

(22) Filed: Feb. 22, 2006

(51) Int. Cl. A01K 87/08; A01K 87/00

(52) U.S. Cl. 43/23; 43/18.1 R

(57) ABSTRACT

A fishing rod assembly is provided in which a sports style grip is incorporated into the rod handle. Sports include, but are not limited to—golf, tennis, baseball, pool, hockey, hunting, motorcycling, and auto racing. The sports style grip is representative of a grip found on a piece of equipment used by a participant of a particular sport. For example a grip used for a golf club or tennis racket, the handle of a baseball bat or pool cue, or the stick shift found in a sports car.

### BACKGROUND ART

The present invention relates in general to fishing rods, and more particularly to a fishing rod with a sports style handle.

Modern fishing rods tend to be similar with their design centered primarily on performance. Visit any large retailer of fishing equipment, and the reader will feel as though surrounded by a forest of fishing rods, all in rows, with nearly indistinguishable shafts, and handles alternating mostly between cork and a plurality of black synthetic materials. While there are a wide variety of grips, they tend not to vary too much in their basic design. Most are simply cylindrical with a bit of contouring aimed at giving the angler an improved grip on the rod assembly.

However, many anglers enjoy a sense of style based on their choice of fishing equipment. Fishing equipment such as boats, tackle, and apparel all have distinct visual aspects aimed at attracting the discriminating angler. In addition, it is not uncommon for participants of other sports to be attracted to fishing, bringing with them a preference for the style of grip used in their particular sport. What is needed is a fishing rod that appeals to both of these type anglers—one that provides a distinct visual quality for the discriminating angler, while at the same time offering a familiar grip to the sports crossover angler.

The art of fishing rod assembly is well known. Fishing rods have been assembled around tapered hollow tubes for many, many years. The tapered hollow tubes are called rod blanks. Most modern fishing rods are made from rod blanks of fiber reinforced synthetic resin, with the rod blanks tapering from a butt-end having a larger diameter to a tip-end having a smaller diameter. A rod handle comprising a reel seat and grips, along with line guides, and tips are mounted on the rod blanks to complete the finished fishing rod assembly.

Of the components listed above, the rod handle offers the greatest opportunity for creating a rod that appeals to both the discriminating and sports crossover angler. The rod handle offers considerable surface space per longitudinal unit compared to the rod shaft, which is typically a thin tapered rod whose diameter is commonly measured in fractions of inches. In addition, the profile of the rod handle can be varied considerably without greatly impacting the overall performance of the fishing rod assembly.

Rod handles are comprised of one or more grips, and a reel seat. While the design and material composition of these components may vary, their purpose and their relation to each other are generally the same. A grip is held by the angler, and the reel seat attaches the reel to the rod assembly. When there are two grips, the butt grip is located at the end of the handle farthest from the rod blank, and the fore grip is located adjacent to the rod blank. The reel seat either lies in between the grips when there are two, or adjacent to the grip when there is one.

### SUMMARY OF INVENTION

The present invention provides a fishing rod assembly that incorporates a sports grip into its rod handle. The sports grip is representative of a grip found on a piece of equipment used by a participant of a particular sport. For example a grip used for a golf club or tennis racket, the handle of a baseball bat or pool cue, or the stick shift found in a sports car.

An object of the present invention is to provide the discriminating angler with a fishing rod that has a distinctive handle.

Another object is to provide the sports crossover angler with a fishing rod that has a handle that has familiar feel based on the angler's customary sport.

### DRAWING FIGURES

FIG. 1 shows a side elevation of a casting style fishing rod with a golf grip sports handle.

FIG. 2 shows a side elevation of a rod handle incorporating a golf grip.

FIG. 3 shows a side elevation of a rod handle incorporating a tennis racket grip.

FIG. 4 shows a side elevation of a rod handle incorporating a pool cue handle.

FIG. 5 shows a side elevation of a rod handle incorporating a baseball bat handle.

### REFERENCE NUMERALS IN DRAWINGS

10 fishing rod assembly
12 rod blank
14 butt-end of rod blank
15 tip-end of rod blank
16 guides
17 tip guide
20 rod handle
21 butt grip
23 reel seat
22 fore grip
30 longitudinal axis

### DESCRIPTION OF INVENTION

For the purpose of promoting an understanding of the principles of the invention, reference will now be made to the embodiments illustrated in the drawings, and specific language will be used to describe the same. However, it is to be understood that the disclosed embodiments are merely exemplary of the invention that may be embodied in various and alternative forms. The figures are not necessarily to scale, and some features may be exaggerated or minimized to show details of particular components.

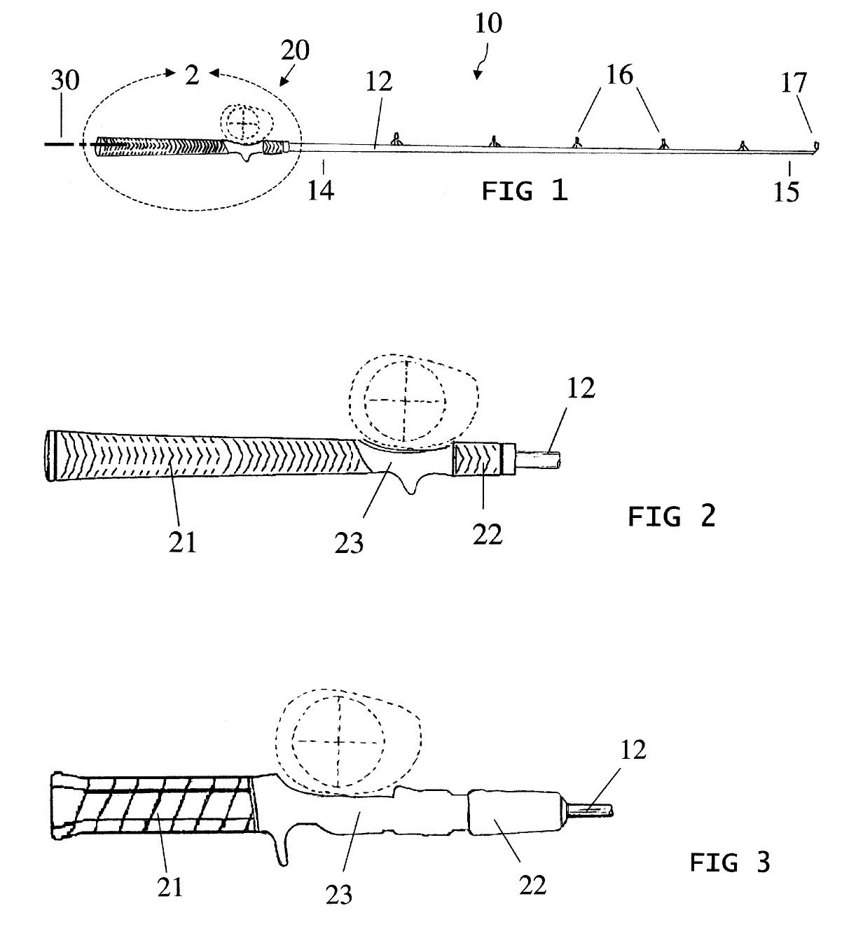

FIG. 1 shows a fishing rod assembly 10 embodying the concepts of the present invention. Although the exemplary rod assembly 10 depicted and described is of the type employed primarily for casting and spincasting, these concepts can be adapted to the individual rod styles employed for all types of fishing.

Fishing rod assembly 10 is comprised of a rod blank 12 having a tip end 15 and a butt end 14, a customary plurality of line guides 16 and a tip guide 17, and a rod handle 20 located attached to the butt end of the rod. Rod handle 20 comprising a butt grip 21, a fore grip 22, and reel seat 23. As such, the fishing rod blank 12 and rod handle 20 will have a longitudinal axis 30.

FIG. 2 is an enlarged sectional view of rod handle 20 as indicated in FIG. 1. FIG. 2 illustrates an embodiment of the present invention in which a representation of a golf grip is incorporated into rod assembly 10, in this case a casting style rod. Here the golf grip forms both butt grip 21 and fore grip 22 portions of rod handle 20.

FIG. 3 illustrates an alternative embodiment of the present invention in which a representation of a tennis racket grip is incorporated into rod assembly 10, in this case a casting style rod. Here the tennis grip forms only butt grip 21 portion of the rod handle 20.

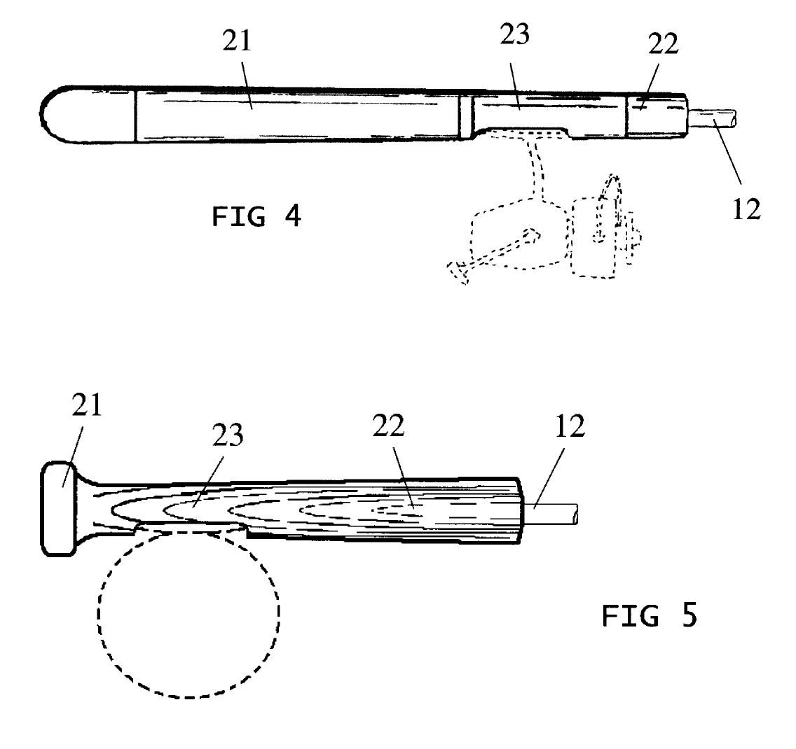

FIG. 4 illustrates an alternative embodiment of the present invention in which a pool cue handle is incorporated into a rod assembly 10, in this case a spinning style rod. Here the pool cue handle forms the entire rod handle 20.

FIG. 5 illustrates an alternative embodiment of the present invention in which a baseball bat handle is incorporated into rod assembly 10, in this case a fly-fishing style rod. Here the baseball bat handle forms the entire rod handle 20.

Although the descriptions above show grips or handles from specific sports integrated into rod handles of particular style rods in a specific manner, this should not be construed as limiting. For example, sports style rod handles can:
Be representative of a plurality of sports,
Take the form of a plurality of grips available for a sport,
Form only the butt grip of a rod handle, the butt grip and the fore grip of a rod handle, or the entire rod handle,
Be incorporated into any of the common rod assembly styles such as casting, spinning, and fly-fishing,
Be made using an actual sports equipment grip or handle modified for use in the rod assembly, or fabricated from a conventional fishing rod grip material such as cork or a synthetic such as Hypalon® to represent a sport grip,
Be of a variety of colors, shapes and sizes.

Furthermore, other modifications of the invention will be apparent to those skilled in the art in light of the foregoing description. The description is intended to provide concrete examples of individual embodiments clearly disclosing the present invention. Accordingly, the invention is not limited to any particular embodiment. All alternatives, modifications, and variations of the present invention, which fall within the spirit and broad scope of the appended claims, are covered.

1. (canceled)

2. A fishing rod assembly comprising a rod blank having a plurality of modes tapering from a butt-end having a larger diameter to a tip-end having a smaller diameter, a plurality of line guides attached to said rod blank in spaced-apart relationship with respect to each other and a tip guide attached to said rod blank at said tip-end, and a rod handle comprising a sports grip or handle at said butt-end and a reel seat, attached to the butt-end of said rod blank.

3. The fishing rod assembly of claim 2 comprising a fore grip provided on said rod blank adjacent to said reel seat.

4. The fishing rod assembly of claim 2 wherein said sports grip is characterized by a baseball bat grip.

5. The fishing rod assembly of claim 2 wherein said sports grip is characterized by a golf club grip.

6. The fishing rod assembly of claim 2 wherein said sports grip is characterized by a pool cue grip.

7. The fishing rod assembly of claim 2 wherein said sports grip is characterized by a tennis racquet grip.
